(19) United States
(12) Patent Application Publication
(10) Pub. No.: US 2016/0180025 A1
(43) Pub. Date: Jun. 23, 2016

(54) Point of delivery signature capture to consent for refill prescriptions

(71) Applicants: Kunal Ashok Vyas, Apopka, FL (US); Alan Ramon Gajadhar, Apopka, FL (US)

(72) Inventors: Kunal Ashok Vyas, Apopka, FL (US); Alan Ramon Gajadhar, Apopka, FL (US)

(21) Appl. No.: 14/581,063

(22) Filed: Dec. 23, 2014

(51) Int. Cl. G06F 19/00

(52) U.S. Cl. CPC G06F 19/322; G06F 19/3462

(57) ABSTRACT

Prescription drugs are delivered in packages to patients who, at the same time as signing for the package, can provide consent for future refills of the prescription drugs to be delivered. A single electronic signature is obtained from the patient, which serves both as acknowledgment of receipt of the package and as consent for future refill delivery. The patient is able to individually select which of the prescription drugs in the package are to be refilled in a subsequent delivery. Auditable evidence of the consent can be provided by the system as and when required.

### TECHNICAL FIELD

This application relates to electronically capturing signatures. More specifically, it relates to the capture of a consent signature during a current delivery of drugs for which the prescription is to be refilled during a future delivery.

### BACKGROUND

When patients are prescribed ongoing courses of medication, pharmacies may provide the prescription drugs in batches. Repeat or refill prescriptions are provided every month or quarterly, for example, by the pharmacy to the patient. In many cases, the prescription drugs are couriered to the patient. For all types of drug, the patient should provide consent to the pharmacist before the pharmacist can provide the drug. For some types of drug, the patient must provide written consent to the pharmacist.

In some situations, the patient will phone the pharmacy to request that a refill prescription be couriered, which is acceptable in cases where verbal consent is sufficient. In other situations, a staff member at the pharmacy will phone the patient to request if the refill drugs are required and to request consent to courier them. In other cases, especially if written consent is needed, then the patient must go to the pharmacy in person, or otherwise arrange for the written consent to be delivered to the pharmacy.

When pharmacies phone patients in order to get their consent to deliver refill prescriptions, it takes considerable time and effort and, as well, they find that a significant portion of the patients cannot be reached. This is a particular problem for the larger pharmacies that courier, for example, several hundred or thousand prescriptions per day.

Oftentimes, the various different consents are noted in different ways and in different places, such as in a notebook or on pieces of notepaper, which can become very difficult to track and/or decipher, especially if an audit is required.

This background information is provided to reveal information believed by the applicant to be of possible relevance to the present invention. No admission is necessarily intended, nor should be construed, that any of the preceding information constitutes prior art against the present invention.

### SUMMARY OF INVENTION

The present invention is directed to a method and system for electronically capturing signatures representing consent to deliver future refill prescription drugs. At the point of delivery of a package of prescription drugs, a signature is electronically captured for a subsequent refill of some or all of the same prescription drugs. Optionally, a date, specified day of the week and/or specified time for future delivery of the refill may also be obtained at the point of delivery.

The system includes a client device (hereinafter for sake of brevity referred to only as “client”) for entering details of prescription drugs that are to be delivered in a package, commanding a printer to print a label for the package, tracking orders and auditing consent for future refills. The system also includes a server that stores and updates patient information and order information, and sends information to the client when requested. The server also sends information to and receives information from an electronic signature pad, which in fact is a further client. The electronic signature pad is configured to accept signatures electronically on a touch-sensitive surface, such as a touch screen. The electronic signature pad also permits patients to select which individual prescription drugs they wish to give future delivery consent for.

Patients only need to sign once when receiving a package, as the signature both confirms the current delivery and provides consent for future deliveries.

Disclosed is a system for obtaining consent to deliver refill prescription drugs comprising a client configured to: receive an identification of a patient; receive identifications of one or more prescription drugs that have been prescribed to the patient; define a job that relates the patient to said drugs; receive a command to print a label for a package in which said drugs are to be delivered to the patient, said label encoded with an identification of the job; and transmit details of the job via a network. The system also includes a server connected via the network to the client, the server configured to receive details of the job transmitted from the client. The system further includes an electronic signature pad connected via the network to the server, the pad configured to: receive identification of the job; receive identification of the patient; retrieve the identifications of said drugs from the server; display identification of the patient; display identification of the job; display a consent statement for future delivery of one or more of said drugs comprising an identification of each of said drugs and an individual selector for each of said drugs; receive a selection from the patient of one or more of said drugs; receive a signature from the patient for the consent statement, the signature also acknowledging receipt by the patient of the package; and transmit the selection of one or more of said drugs and the signature to the server.

Further disclosed is a method for obtaining consent to deliver refill prescription drugs comprising receiving, by a client, an identification of a patient; receiving, by the client, identifications of one or more prescription drugs that have been prescribed to the patient; defining, by the client, a job that relates the patient to said drugs; receiving, by the client, a command to print a label for a package in which said drugs are to be delivered to the patient, said label encoded with an identification of the job; and transmitting, by the client, details of the job to a server. The method includes receiving the identification of the job by an electronic signature pad connected via a network to the server; receiving, by the pad, identification of the patient; retrieving, by the pad, the identifications of said drugs from the server; displaying, by the pad, identification of the patient; displaying, by the pad, identification of the job; displaying, by the pad, a consent statement for future delivery of one or more of said drugs comprising an identification of each of said drugs and an individual selector for each of said drugs; receiving, by the pad, a selection from the patient of one or more of said drugs; receiving, by the pad, a signature from the patient for the consent statement, the signature also acknowledging receipt by the patient of the package; and transmitting the selection of one or more of said drugs and the signature from the pad to the server.

Still further disclosed are computer readable media comprising computer readable instructions that, when executed by one or more processors, cause a client to: receive an identification of a patient; receive identifications of one or more prescription drugs that have been prescribed to the patient; define a job that relates the patient to said drugs; receive a command to print a label for a package in which said drugs are to be delivered to the patient, said label encoded with an identification of the job; and transmit details of the job via a network. The instructions further cause a server, connected via the network to the client, to receive details of the job transmitted from the client; and an electronic signature pad, connected via the network to the server, to: receive identification of the job; receive identification of the patient; retrieve the identifications of said drugs from the server; display identification of the patient; display identification of the job; display a consent statement for future delivery of one or more of said drugs comprising an identification of each of said drugs and an individual selector for each of said drugs; receive a selection from the patient of one or more of said drugs; receive a signature from the patient for the consent statement, the signature also acknowledging receipt by the patient of the package; and transmit the selection of one or more of said drugs and the signature to the server.

### BRIEF DESCRIPTION OF DRAWINGS

The following drawings illustrate embodiments of the invention, which should not be construed as restricting the scope of the invention in any way.

FIG. 1 is a schematic representation of a system for obtaining consent to deliver refill prescription drugs according to an exemplary embodiment the present invention.

FIG. 2 is a schematic representation of the modules in the system according to an exemplary embodiment of the present invention.

FIG. 3 is a schematic representation of a screen shot displayed by a client according to an exemplary embodiment of the present invention, for the input of information relating to packages of refill prescription drugs that are to be couriered.

FIG. 4 is a schematic representation of a screen shot of an electronic signature pad for obtaining consent to refill future prescriptions, according to an exemplary embodiment of the present invention.

FIG. 5 is another schematic representation of a screen shot of the exemplary client when used to track the delivery status of packages of refill drugs, including tracking consent for future prescriptions.

FIG. 6 is another schematic representation of a screen shot of the exemplary client, showing an audit report for a delivered order that includes electronic copies of a consent signature.

FIG. 7 is a flowchart of steps that are taken by a client in an exemplary method according to the invention.

FIG. 8 is a flowchart of steps that are taken by an electronic signature pad in an exemplary method according to the invention.

### DETAILED DESCRIPTION

### A. Glossary

The term “prescription”, when used in its more general sense, is an order by a health care worker to a pharmacist to supply one or more drugs or medications to a patient. Specifically, the term “prescription” may also be used to refer to a single drug item, which may be one of several drugs prescribed at the same time and listed on the same general prescription.

The term “job” relates to a single order, which may include one or more different prescription drugs. A job may be for delivery by the pharmacy or a courier, or for pickup by the patient. Items other than prescription drugs may be included in the job, and in some cases the job may just be one or more of these other items without a prescription drug. The term “job” is synonymous with the term “order”.

The term “user” is used herein to refer to the person who uses the system to prepare drug packages and to schedule their delivery, and is typically a pharmacist or a pharmacy technician.

The term “driver” is used to refer to the person who delivers a package of prescription drugs, but this person may also be a pharmacy technician.

The term “module” can refer to any component in this invention and its network and to any or all of the features of the invention without limitation.

The term “network” can include both a mobile network and data network without limiting the terms meaning, and includes the use of wireless (2G, 3G, 4G, WiFi, WiMAX™, Wireless USB (Universal Serial Bus), Zigbee™, Bluetooth™ and satellite), and/or hard wired connections such as internet, ADSL (Asymmetrical Digital Subscriber Line), DSL (Digital Subscriber Line), cable modem, T1, T3, fiber, dial-up modem, and may include connections to flash memory data cards and/or USB memory sticks where appropriate. A network could also mean dedicated connections between computing devices and electronic components, such as buses for intra-chip communications.

The term “hardware” includes, but is not limited to, the physical housing for a computer as well as the display screen, connectors, wiring, circuit boards having processor and memory units, power supply, and other electrical components.

The term “software” includes, but is not limited to, program code that performs the computations necessary for calculating and optimizing user inputs, the reporting and analysis of patient, prescription and package specific data, displaying information, and, managing of input and output data.

The term “firmware” includes, but is not limited to, program code and data used to control and manage the interactions between the various modules of the system. Firmware persistently stores updatable processor readable instructions and data.

The term “server” is used to refer to any computing device, or group of devices, that provide the functions described herein as being provided by one or more servers.

The term “client” refers to any computing device that accesses the services of a server. A thick or fat client has significant processing power and capabilities in itself, independent of the server. A thin or slim client has zero or minimal processing capabilities, and relies heavily on the server to fulfill its computational roles.

The term “processor” is used to refer to any electronic circuit or group of circuits that perform calculations, and may include, for example, single or multicore processors, an ASIC (Application Specific Integrated Circuit), and dedicated circuits implemented, for example, on a reconfigurable device such as an FPGA (Field Programmable Gate Array).

The term “database” refers to both persistent and volatile means of storing information suitable for performing computing functions such as searching, inserting and updating. Typically, these are relational databases such as in MySQL (My Structured Query Language). It is also possible to use no-SQL databases, in-memory data structures, plain computer files or any other means of storing data. A database may be a parallel system database in which the processors are tightly coupled and constitute a single database system or may be a distributed database in which storage devices are not all attached to a common processing unit such as a CPU (Central Processing Unit), and is controlled by a distributed database management system. A distributed database system may be stored in multiple computers, located in the same physical location; or may be dispersed over a network of interconnected computers.

### B. System

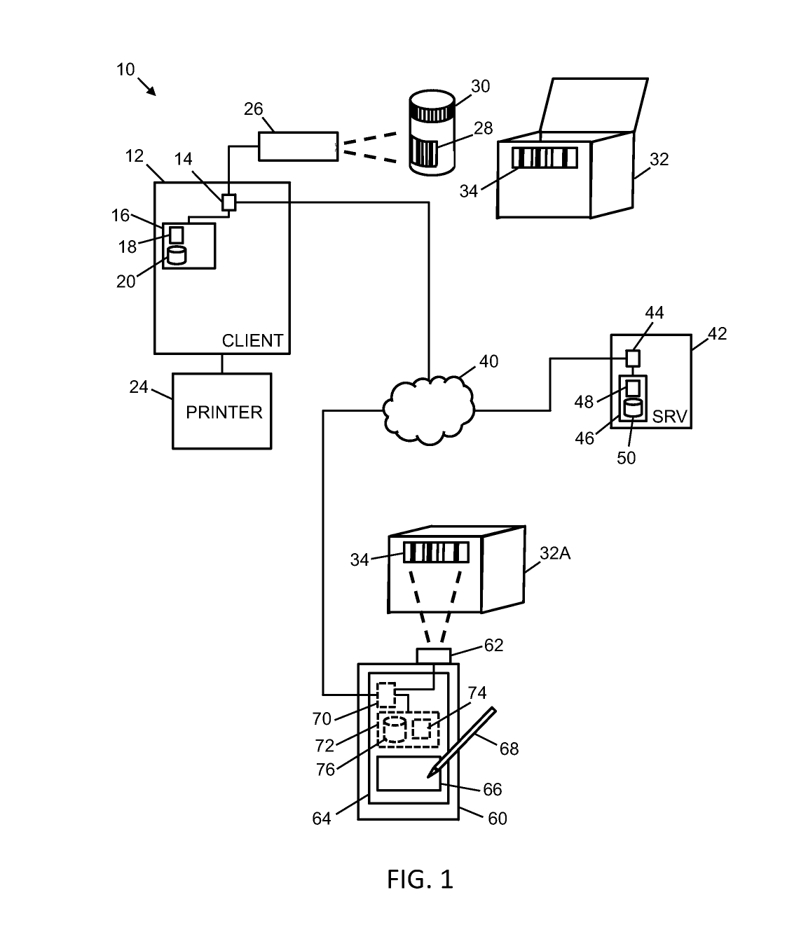

Referring to FIG. 1, an exemplary system 10 is shown for the electronic capture of signatures at the point of delivery of prescription drugs, the signatures representing consent for future delivery of some or all of the same prescription drugs. The system 10 comprises a thick client 12, such as a desktop personal computer with keyboard and display screen. The client 12 includes one or more processors 14 that are connected to one or more computer readable media 16, which include computer readable instructions 18 and computer readable data 20. The computer readable instructions 18, when executed by the processor(s) 14, cause the client to perform one or more of the methods of the present invention described below.

The client 12 is connected to a printer 24, and is either wired or connected wirelessly thereto. The client 12 is also connected to a bar code scanner 26, which may be any type of bar code scanner. The bar code scanner 26 should be capable of scanning the bar codes 28 attached to drug containers 30. The bar code scanner 26 sends the information in the bar code 28 to the client 12. This information includes at least the identification number of the prescription drug that is inside the drug container 30. The identification number of the drug may be appended with a sequential number indicating the number of times that the specific drug has been ordered by the same patient.

Prescription drugs that have been scanned, or have otherwise had their identification numbers entered into the client 12, are placed in a package 32 for delivery to the corresponding patient. The system 10 can be used to consolidate multiple prescription drugs for the same patient. The printer 24 is used, upon receiving a command from the client 12, to print a package label, which at least includes a bar code 34. The package bar code 34 includes an identification number of the package, which is related to the identification numbers of the individual prescriptions that have been placed in the package. Other information that is printed on the package label may of course include the patient's name and address.

The client device 12 is connected via a network 40 to a server 42. The network 40 may be the internet, an Ethernet, a cellular network or any combination thereof, and the connection between the client 12 and the network may be wired or wireless. The server 42 includes one or more processors 44 that are connected to one or more computer readable media 46, which include computer readable instructions 48 and computer readable data 50. The computer readable instructions 48, when executed by the processor(s) 44, cause the client to perform one or more of the methods of the present invention described below. The data 50 may include one or more databases that relate patients to specific prescriptions and packages or jobs.

Also connected to the network 40 is an electronic signature pad 60, which is carried by the driver, pharmacy technician or other delivery agent that is delivering the now closed package 32A to the corresponding patient. The electronic signature pad 60 includes functionality that goes beyond the capture of signatures, and is equipped, for example, with a bar code scanner 62, which is able to scan the bar codes 34 on the closed package 32A. The bar code scanner 62 may be a peripheral component to the electronic signature pad 60, mounted on it, wired to it or connected wirelessly to it, or it may be a component integral to it. The electronic signature pad 60 has a touch sensitive display screen 64 on which is displayed a signature area 66. A stylus 68, which is designed to work with the particular type of touch sensitive screen 64, is used by patients to sign in the signature area 66 at the time of receiving a package 32A. In some embodiments a patient's finger may be used to write the signature instead of the stylus 68.

The electronic signature pad 60 includes one or more processors 70 that are connected to one or more computer readable media 72, which include computer readable instructions 74 and computer readable data 76. The computer readable instructions 74, when executed by the processor(s) 70, cause the client to perform one or more of the methods of the present invention described below.

The system 10 may also be used for prescriptions that are to be picked up from the pharmacy and for prescriptions that do not require a signature for future delivery.

### C. Modules

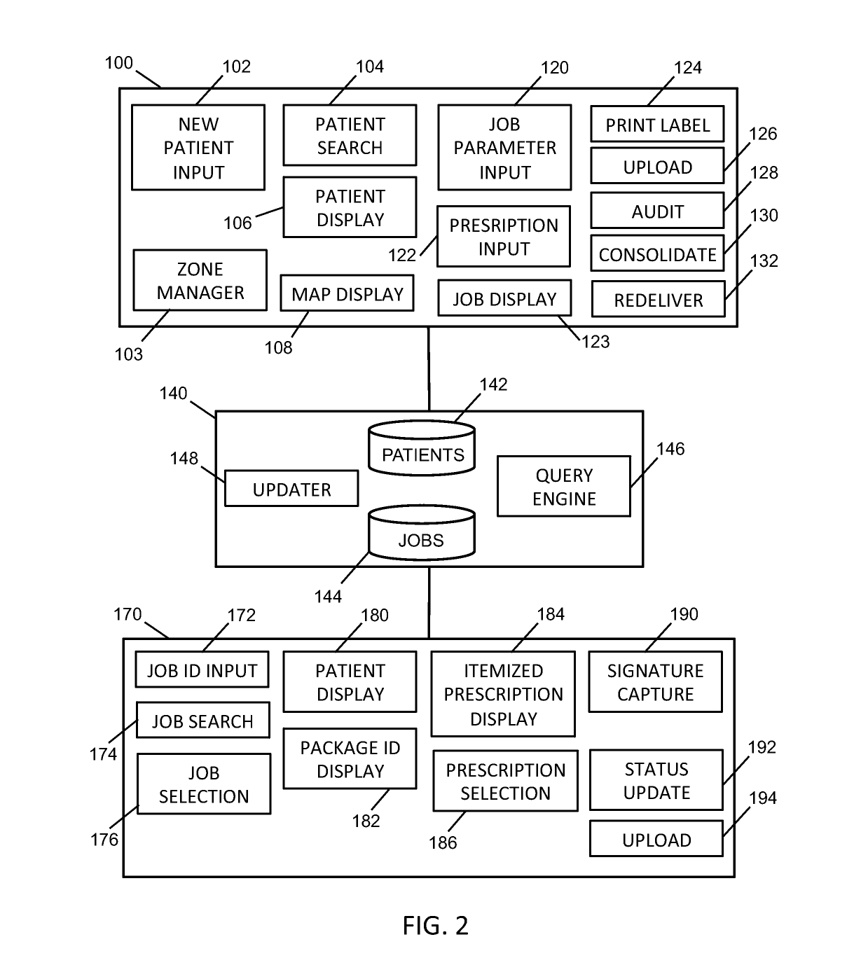

Referring to FIG. 2, some of the key modules of the exemplary system 10 are shown. Group 100 includes modules that are encoded as computer readable instructions 18 in the client 12, and which also may interact with one or more modules 140 of the server 42.

The new patient input module 102 allows the details of new patients (i.e. customers to the pharmacy) to be added to the system 10, via client 12. Such details may include a full name, address whether the patient is active or not and any comments that may be pertinent to the patient. The details also include a customer number, which may be automatically generated and/or provided to the client by the server 42. Upon adding the new patient to the system, the details of the patient are stored in a database within data 50 in the server 42.

Management of the delivery zones is done using the zone manager module 103. The delivery zone the patient lives in is automatically determined from the patient's zip code. Delivery zones are dynamic, in that they may be changed depending on the number of deliveries in a particular area, the number of delivery personnel, etc.

The patient search module 104 allows a user of the client 12 to enter search terms for a patient. Search may automatically begin as soon as the user starts typing something in a search field, for example. Search may be by name, address, delivery zone, customer number, phone number, etc.

The patient display module 106 displays a scrollable list of patients on the client 12, with summary or abbreviated patient details in each list item. The number of patients in the list could be a fraction of the patients recorded in the system or all of them. Depending on the embodiment, there could be several thousand patients listed in the system 10. As the search term is entered, the list that is displayed could automatically be reduced in size. When the user selects a patient from the list, or nudges a highlighted selection bar up or down in the list, complete or extended details corresponding to the patient selected are displayed in another area of the client screen.

The map display module 108 causes the display, on a screen of the client 12, of a map that pinpoints the address of the selected patient. Map information may be retrieved from a third party provider such as Bing™ or Google™, for example. Map display module 108 may also include displaying a photograph of the patient's house, which may be displayed automatically based on the patient's address retrieved from the selected patient details. Again, the photograph may be provided by a third party service such as Bing Streetside™ or Google Street View™.

The job parameter input module 120 allows a user to enter parameters of a job into the system 10, via the client 12. When a new job is started, the system 10 assigns a unique job identification number to the job. The parameters entered will be related to the patient that is currently selected, and will relate to a package 32 that is being prepared for the patient. The parameters include: Type, the value of which may be selected from a pull-down menu of Pick-up or Delivery; Courier, the value of which may be selected from a pull-down menu of names of third party couriers and in-house couriers; Method, the value of which may be selected from a pull-down menu of Standard, Same Day, Next Day, Rush, Long Distance.

The prescription input module 122 permits a user of the client 12 to input an identification number of a prescription drug into the system 10 via the client. The prescription number entered will be related at the server 42 to the selected patient and the job that is being entered. Multiple prescription numbers can be added for the same job, each prescription number corresponding to a different drug. The prescription numbers may be entered by scanning bar codes 28 on the drug containers 30, or by a user of the client 12 typing in the prescription numbers directly.

The print label module 124 allows a user of the client 12 to print a label 34 for the package 32 that is being prepared for the patient. This may be done after all the prescription numbers of the job have been entered, and also after the job parameters have been entered.

The upload module 126 is invoked in conjunction with the print label module 124. Since, ideally, the label should only be printed when the job has been fully defined and entered into the client, only then can the data pertaining to the job be uploaded to the server 42. Data is uploaded by the upload module 126.

The audit module 128 allows a user of the client 12 to search completed or incomplete jobs in order to review whether a package was delivered, when it was delivered, whether a signature was provided to the system 10 by the recipient of the package, whether the signature represented consent for the pharmacy to deliver a future refill prescription, etc. The audit module 128 allows a user to input one or more search terms into the client 12 which are then used to query the data 50 stored in the server 42. Alternately, the client may store a cache of some or all of the data 50 its own memory, which may instead be queried.

The consolidate module 130 allows a user to view patients that have had deliveries of drugs on multiple occasions within a specified recent time period, such as two weeks, a month or a quarter. By finding such groups of deliveries from an order history, one or more of the quantities of the prescription drugs can be altered in subsequent deliveries so that eventually all drugs due to be delivered within the specified time period can be delivered in one consolidated package. The consolidation module 130 may be run manually, as and when the pharmacy has the time to alter the prescription quantities. Alternately, it may be run automatically, such as once a month, every week or every day. It may operate in real time, so that as soon as a second delivery to the same patient within the specified time period is created, the user is notified so that either the current prescription drug amount can be altered or one of the following prescription drug amounts can be altered. The time period may be different for different types of drug, and/or different patients. The server may be configured to identify the packages of different prescription drugs that have been delivered to the patient within a selected period of time; and the client may display a representation of such identified packages.

The redeliver module 132, when activated, selects all jobs from the previous day that need redelivering. It may automatically add some or all of them to the current day's delivery schedule, or it may be configured to allow the user to manually add or block certain deliveries, or to set a specific redelivery date and/or time in the future. An automatic route planner then incorporates the redelivery jobs into the current day's schedule and/or a future day's schedule, which may not be finalized until the morning of, or night before, the day in question.

Group 140 of the modules includes modules that are encoded as computer readable instructions 48 and data 50 in the server 42, which also may interact directly or indirectly with one or more modules 100 of the client 12 and/or one or more modules 170 of the electronic signature pad 60.

The patient module 142 is a global database, in data 50, of all the patients that are entered in the system 10 including all the relevant details that have been input into the system.

The job module 144 is a global database, in data 50, of all the jobs that have been entered in the system 10 including all the corresponding job parameters and prescription drug numbers.

The query engine module 146, within instructions 48, is used by the server 42 to query the databases of the patient module 142 and the job module 144. These databases can be queried based on search terms entered via the client 12 or the electronic signature pad 60 and transmitted via the network 40 to the server 42.

The updater module 148, within instructions 48, is used for updating the databases of the patient module 142 and the job module 144. The database of the patient module 142 may be updated by the user entering new patient details via the client 12, for example, or by amending existing details of patients. The database of the job module 144 may be updated by the client 12, as a user completes the definition of a new job or amends an existing job. The database of the job module 144 may also be updated by the electronic signature pad 60, as a driver specifies that a package has been delivered or that a patient's signature has been received, for example. The driver may also update the status of a job if it is undeliverable, for example, using the update module 148.

Group 170 includes modules that are encoded as computer readable instructions 74 in the electronic signature pad 60, which also may interact with one or more modules 140 of the server 42.

Job ID input module 172 allows a driver to input an identification number of a package into the signature pad 60, either by directly typing the number, starting to type the number which auto-completes, or by scanning the bar code 34 on the package 32A.

Job search module 174 permits the identification of a job to be searched for based on details entered in a search field such as a patient name, address or partially entered patient name or job identification number.

Job selection module 176 allows a driver to select the correct job from a shortlist of jobs that are possible matches for a search term or partially entered patient name, the shortlist being automatically displayed on the screen 64 of the signature pad 60.

Patient display module 180 displays on screen 64 the name of the patient to whom the package in hand is to be delivered. This is based on the patient name having been retrieved from the database of patient module 142, following the ID of the package having been input into the signature pad 60, or having otherwise been identified.

Package ID display module 182 displays the identification number of the package that is being delivered on the screen 64 of the signature pad 60.

Itemized prescription display module 184 displays a list of all the drugs in the package 32A that is being delivered.

Prescription selection module 186 displays a selection box beside each listed drug in the package 32A. Each individual drug can be selected independently of the others, depending on which ones the patient wants to receive a future delivery of.

The signature capture module 190 captures a patient's signature traced on the signing area 66 of screen 64 of the electronic signature pad 60, the signature having been traced using stylus 68 or equivalent. The signature captured may be that of a parent of the patient if the patient is a child, or another representative of the patient who can sign on their behalf. A benefit of the system is that only a single signature is required, that is valid both for confirmation that the package has been received and for consent for future deliveries of prescription drugs. A further benefit is that the pharmacy can better plan how to restock drugs that are subject to refill, since they have now been informed much earlier than they would have been if consent were obtained by phone or in person at the pharmacy.

The status update module 192 allows the driver to update the status of the job. The status may be selected from a pull-down menu of: Finished, i.e. the package has been delivered, properly received and signed for; Canceled, i.e. the package no longer needs to be delivered; Suspended, i.e. there is nobody to sign and so the package cannot be immediately delivered but should be delivered later; Rejected—the package was rejected by the intended recipient. Other status values are also possible.

The upload module 194 allows the driver to activate a ‘Done” button displayed on the screen 64, after a package has been delivered and a signature has been received, or after the status of the job has been changed. When the driver sets a new status, it is sent to the server 42 with an electronic copy of the signature received, if any, and an indication of which of the prescription drugs have been selected for future delivery. At the server 42, the updater module 148 then amends the database of the job module 144 accordingly. As a result, confirmation of the delivery can be stored in near real-time in the server 42. Furthermore, immediate confirmation of consent for the future refills can be obtained and recorded in the server 42. This obviates the need for the pharmacy to phone the patient and/or for the patient to later provide a signature to the pharmacy.

### D. Screen Shots

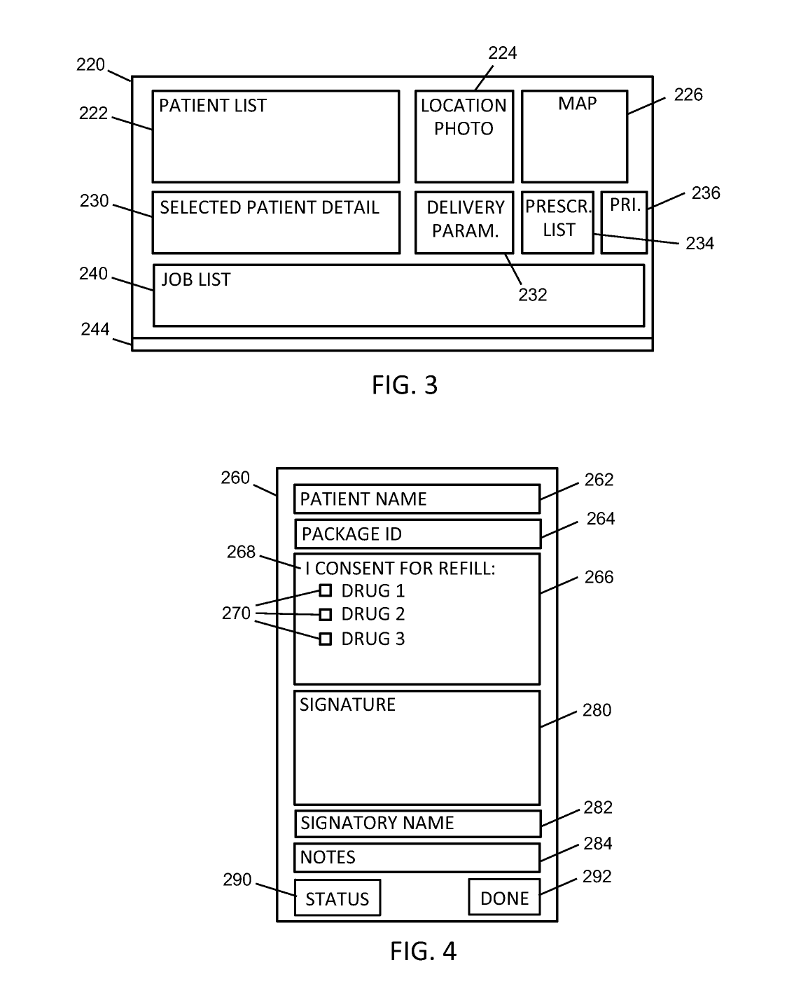

Referring to FIG. 3, a screen shot 220 of the client 12 is shown. Area 222 of the screen is a listing, or partial view of a listing, of the patients recorded in the patient module 142 of the server 42, and displayed by patient display module 106. Area 224 is a photograph of the home or other delivery address of the patient. Area 226 is a map that pinpoints location of the delivery address. Areas 224 and 226 are displayed by map module 108. At 230, the complete detail of a patient highlighted in the patient list 222 is displayed by patient display module 106. Area 232 displays pull-down menus of the various parameters that may be selected to define a delivery, provided by job parameter input module 106. Area 234 is a list of prescription drugs whose bar codes have been scanned or otherwise entered into the client 12, these being for the job for which the delivery parameters have been defined. Area 234 includes a field for directly entering a prescription number, provided by prescription input module 122. Soft button 236 will start the printer 24 printing a label 34 for the package 32 after the job has been fully defined, as provided by print label module 124. Area 240 is a list of the jobs that have been entered into the system 10, provided, for example, by job display module 123. The jobs may be color coded or otherwise identified as to their status, which may be, for example: Started, where the parameters of the delivery or identifications of the drugs have started to be entered into the client 12; Created, where the parameters have been fully defined, the identification numbers of the prescription drugs have all been input and the print label button 236 has been activated.

The appearance and layout of screen shot 220 and other screen shots disclosed herein may be different in other embodiments, for example, to conform to the look and feel of existing applications or corporate styles. The positions of various areas 222-240 of the screen shot 220 may, in some embodiments, be configurable by the user. Some of the areas 222-240 may be dragged into a different window on the user's device, or may not be displayed at all, because the user does not want to use them. For example, the user may not require seeing a photo of the delivery address, and so would not display area 224.

A menu bar 244 may be displayed with one or more buttons or links that provide access to the user to other modules of the system. For example, the menu bar could provide access to the zone manager module 103 and/or the consolidation module 130.

Referring to FIG. 4, a screen shot 260 of the electronic signature pad 60 is shown. Area 262 displays the name of the patient to whom the package 32A in hand is to be delivered, and may be provided by patient module 180, for example. Initially, patient name area 262 may be a blank data entry field, in which the driver starts to type the name of the patient to whom the package is to be delivered. The patient name area 262 may be automatically filled by the pad, or the pad may display a limited number of patients from which the selection of the correct one must be made by the driver. Area 264 is a display of the identification number of the package 32A in hand, which is about to be received by the patient, such display being provided by package ID display module 182. In this area there also may be wording such as “Package received” to expressly indicate to the patient that the signature is at least to confirm receipt of the package. Initially, the package ID area 264 may be blank, and only be completed after the driver has made a selection of available packages that are listed on the pad 60 by job selection module 176. This is done inherently with the selection of the patient, since the patient and package numbers are listed together. Area 266 is the display of the consent statement. It may display wording such as, “I give consent for future refill:” or similar effective wording, followed by an individually selectable itemized list of drugs that are currently being delivered in the package 32A in hand. The individual prescription drugs may be listed by identification number, by drug name, or by both identification number and drug name. Each individual prescription drug that is listed, by itemized prescription display module 184, has a selection box 270 or other selector displayed alongside it, by prescription selection module 186, which may be selected by touch or by selection with the stylus 68. Below the consent statement area 266 is the signing area 280, provided by signature capture module 190, in which a patient or other authorized recipient can sign using the stylus 68. The signature is displayed in area 280 as it is being traced. Area 282 displays the printed name of the signatory, which may be the patient or patient's authorized recipient. Notes area 284 displays notes that have been input into the system 10, either via the client 12 or via the electronic signature pad 60. The notes may relate to the patient or to the job. Further notes may be added in this area 284 by the driver. Area 290 is the display of the status of the job and of a pull-down menu of other possible delivery statuses, from which the driver can set the current delivery status. Soft button 292 is a “Done” button, which the driver activates when information entered into the electronic signature pad 60 is ready for upload to the server 42. Such information includes identifications of the drugs selected for future refill, the recipient's signature, any new notes added and/or a status change.

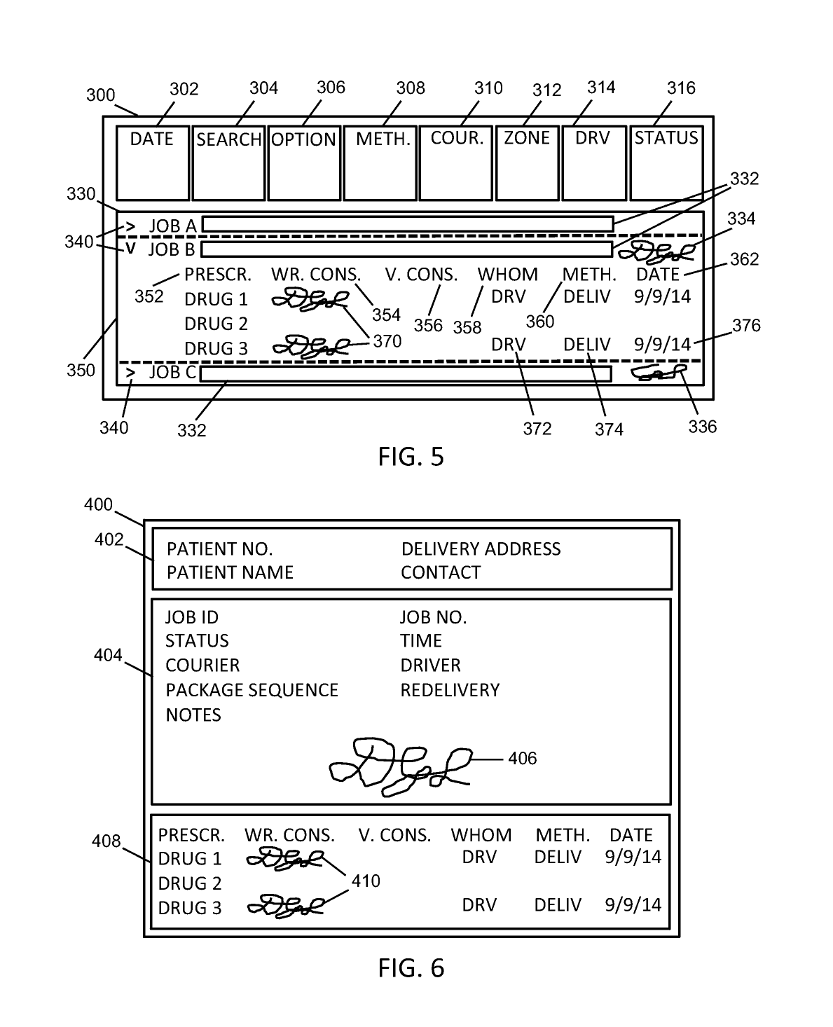

Referring to FIG. 5, a screen shot of the client 12 is shown when a user of the client is performing an audit, as provided by audit module 128. One or more jobs, patients or individual prescriptions may be audited via this screen 300. Various search parameters may be input or selected in order to find the database entries for the items to be audited. For example, there may be a calendar area 302 in which a date or range of dates may be selected. Area 304 may be for entering search terms such as patient first name, last name and/or prescription number. Other parameters may be the name of a pharmacy if the system is used to serve multiple pharmacies. Area 306 allows the search to be limited by options such as whether a signature was required or not, whether the drug needed to be refrigerated in transit or not, and whether the status of the job is Started or Created, or whether the job is for pickup or delivery. Area 308 is for limiting the search by Method, i.e. standard, same day, next day, rush or long distance. Area 310 is for selecting the courier. Area 312 is for selecting the delivery zone. Area 314 is for selecting the driver. Area 316 is for selecting the status of the delivery (for jobs that are delivered), e.g. arrived at delivery location, delivery started, delivery finished, driver departed from delivery location, delivery resumed, delivery canceled, delivery rejected, and delivery suspended.

Below the search parameter entry area 302-316 is a listing area 330, which lists the jobs that correspond to the search parameters that have been entered. For example, for each of the jobs A, B and C that have been listed, for example by job identification number, there is a summary block 332, which includes the job creation date, the patient name, the delivery address, the job status, the delivery status, the delivery zone, etc. To the right of the summary blocks 332 is a space for displaying an electronic copy of a signature 334, 336 if a signature has been obtained to confirm receipt of the delivery. Each job listing can be expanded and contracted by clicking on expansion/contraction buttons 340. For example, job B has been expanded in area 350 to show various columns: Prescription 352, in which an itemized list of the individual prescription drugs in the job's package is displayed; Written Consent, showing an electronic copy of the signature given for each consent for a future refill of the drug itemized in the corresponding row; Verbal Consent 356, if verbal consent for future delivery has been obtained and written consent is not required; Whom the consent is given to 358, such as a particular driver; Method of how consent was given 360, which may be at delivery, by telephone, by email or in person; and Date 362, which is the date the consent was given. As an example, the pharmacy, via system 10, has been given written consent 370 to deliver a future refill of both drugs 1 and 3, but not drug 2. The consent was given to a driver 372, who was on duty in the zone of delivery at the time the delivery was made. The driver may be specified by initials or name. The identification of the driver is automatically determined since each driver has an assigned signature pad 60 or has to log into the system by providing his identification via the signature pad. The method by which the consent was received was during delivery 374, i.e. on the given date 376. The date displayed may also include the time of the signature, or the time may be displayed in a separate column.

The user may obtain verbal consent via view 300 of the system. If written consent has not been obtained by the driver, and written consent is not needed for the particular prescription drugs in question, then the patient may phone the pharmacy to provide consent for future delivery. In this situation, the user can check the check box 380 in the row corresponding to the drugs to be refilled. Upon checking a check box 380, a pop-up window is displayed that requests the user to input his initials. Upon receiving the user's initials, the system stores them and displays them in column 358 to show whom consent was provided to. Alternately, or as well, the identification of the user can automatically be determined if the user is made to log on to the system prior to using it. Likewise, if only verbal consent is needed and no delivery signature is required, the signature block 280 on the electronic signature pad 60 may not be displayed. In this case, verbal consent for future refills may be obtained by the driver, who would then check the relevant check boxes 270. The driver's initials will be automatically entered in column 358 since he will have had to have previously given his identity to operate the signature pad 60. Alternately, or as well (to give double security), a pop-up on the pad 60 may request the driver to enter his initials.

Note that the electronic copies of the signature 334, 370 all derive from the single signature traced on the electronic signature pad 60 by the recipient of the package.

In this view, it is therefore possible to easily verify whether consent for future deliveries has been provided. An advantage of the system is that it makes the tracking of consent for individual prescription drugs more efficient, because the consents are all automatically collected in a single system.

Referring to FIG. 6, a screen shot of the client 12 is shown, in which a printable audit report 400, for example in PDF format, is shown for a selected job. The information in this screen is the same information as that provided in the expanded area 350 of the screen shot 300 of FIG. 5, and is derived from the data stored about the job and the corresponding patient in the databases of the server 42. In area 402, the patient information is shown, including patient name, patient number (i.e. customer number), delivery address and contact name, which may be the same as the patient or it may be a representative of the patient. In area 404, details of the specific job are shown, including, for example, job number, job ID (e.g. a GUID, or Globally Unique Identification), job status, time completed, name of courier, name of driver or other identification of driver, package sequence (i.e. the position in the ordered list of jobs the driver has to deliver on a specific day), redelivery status (e.g. whether delivery of the package is to be attempted again because there was no-one to sign for it), notes or comments and an electronic copy of the signature 406 as provided by the patient or representative recipient. In area 408 the individualized consent for future delivery of prescription drugs is shown, with corresponding electronic copies of the signature 410.

The audit report 400 can be printed and/or sent to officials who are responsible for auditing the pharmacy in order to ensure that it complies with any necessary regulations. It may also be used by pharmacy benefit managers who want to ensure that their insured patients are being properly served. The data in the audit report, as well as other data collected by the system 10 and stored in the databases in the server 42, may be used to assess HEDIS (Healthcare Effectiveness Data and Information Set) star ratings.

### E. Methods

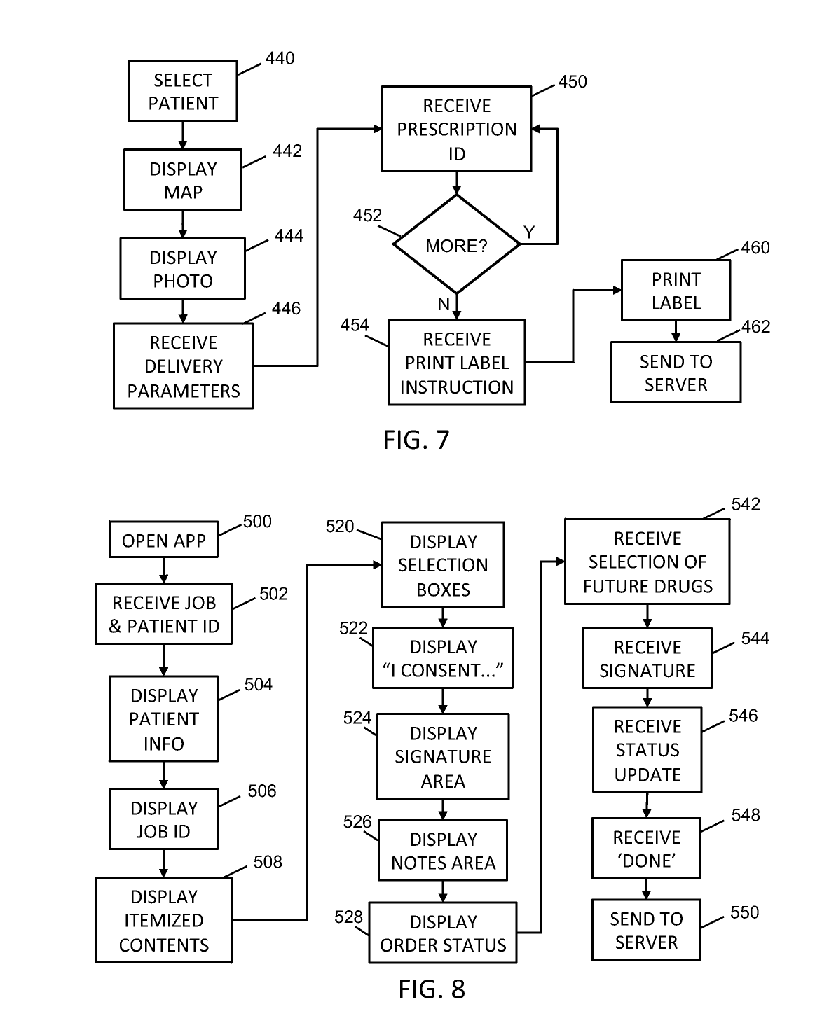

Referring to FIG. 7, a flowchart is shown of an exemplary method that the client 12 undertakes in defining a job. In step 440, the client 12 receives the selection of a patient, as highlighted in patient display module 106. In step 442, the client 12 displays a map, via map display module 108, of the address of the patient, which is the address for delivery of a package 32 containing one or more drugs 30. In step 444, the client displays a photo of the house or other building at the address of the patient. In step 446, the client receives an input of delivery parameters, via job parameter input module 120. In step 450, the client receives an input of an identification of a prescription drug, via prescription input module 122. In step 452, if there are more prescription drugs to be input for the same package, then the method reverts back to step 450. If, in step 452, there are no more prescription drugs to be entered, then the method proceeds to step 454, in which the client 12 receives an instruction to print a label 34 for the package 32, via print label module 124. The printer 24 then prints the label in step 462. In step 462, the client 12 sends the created job information, using upload module 126, to the server 42, which includes the patient identification, the package identification and the identification of each individual prescription drug in the package.

Referring to FIG. 8, a flowchart is shown of a method performed by the electronic signature pad 60 in relation to a package in hand 32A that is about to be delivered to a patient. In step 500, an app is opened on the pad 60, or alternately, the app is already open and is brought to the foreground. In step 502, the pad 60 receives identifications of the job and the patient to whom the package in hand is destined, as provided by job ID input module 172. The pad may receive the patient identification as a result of the bar code scanner 62 on the pad being used to scan the bar code 34 on the package 32A, or by the driver searching for the patient using the search field available on the pad, as provided by modules 174 and/or 176. In step 504, the pad 60 displays the patient information, such as the full name of the patient and optionally the address of the patient, as provided by patient display module 180. In step 506, the pad 60 displays, via package ID display module 182, the identification number of the job, which is also the identification number of the package 32A. In step 508, the pad 60 displays, via itemized prescription display module 184, a list of the itemized prescription drugs in the package 32A. In step 520, the pad 60 displays, via prescription selection module 186, a selection box alongside each listed prescription drug. The pad 60 then displays, in step 522, wording to indicate that a signatory is consenting to a selection of drugs in the itemized list, in area 266 of the pad. In step 524, a signature area is displayed on the pad. The notes display and input area is displayed in step 526. The order status and the pull-down menu for order status change are displayed in step 528. In step 542, the pad 60 receives a selection, via prescription selection module 186, of one or more of the listed prescription drugs that are in the package 32A, which the patient wants to receive a future delivery of. In step 544, the pad 60 receives, via signature capture module 190, the input of a signature from the patient, or patient's representative. In step 546, the pad 60 receives, via status update module 192, a status update of the job, such as job finished, and then, in step 548, receives an indication from the driver that the job has been done and sends, in step 550, the newly entered and updated information to the server 42 via upload module 194.

### F. Variations

Besides a desktop computer, other electronic devices may be used for the client 12, such as a laptop, a notebook or a tablet. The bar codes 28 used for the drug containers may, in another embodiment, be replaced by two-dimension codes, such as quick response codes. Two-dimensional codes can be used to include additional information, such as the name of the prescription drug, its strength and its quantity. Likewise, the bar codes 34 used for the drug packages 32 may, in another embodiment, be replaced by two-dimension codes, such as quick response codes. The electronic signature pad 60 may be an iPhone™, an Android™ device or any other electronic device that provides the required functionality.

The system 10 may be combined with other systems, such as delivery vehicle tracking systems that follow the vehicle using GPS (Global Positioning System) devices, for example. A video chat communications line may be provided between the client 12 and the electronic signature pad 60. Other cloud platforms may be integrated with the system 10. The system 10 may be connected to other similar or other third party systems for the management of prescription drug refills. Fleet management systems and route planning systems may also be integrated. A drug inventory management system may also be incorporated.

While the electronic signature pad 60 has been described predominantly as being operated by a driver, it is to be understood that other users may operate it, such as a co-driver or delivery assistant. The driver may be a pharmacy technician, or other agent of the pharmacy.

Various mechanisms may be put in place to protect the data (i.e. protected health information) in the server, such as firewall protection, encryption, passwords, secure email, secure authentication, etc.

The client and the server may be situated remotely from each other, in different building or in different cities. Alternately, they may be in the same building or even be embodied in the same device. Multiple clients may be connected to the server, so that a common server can manage multiple pharmacies.

The present invention has been illustrated principally in relation to the delivery of prescription drugs that are subject to refill, and to efficiently obtaining the consent to deliver such refills. However, the invention has applications in respect of other areas where repeat orders are common, such as flower delivery, grocery delivery, etc, and where signatures for future deliveries would be needed.

In general, unless otherwise indicated, singular elements may be in the plural and vice versa with no loss of generality.

Throughout the description, specific details have been set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

The detailed descriptions have been presented partly in terms of methods or processes, symbolic representations of operations, functionalities and features of the invention. These method descriptions and representations are the means used by those skilled in the art to most effectively convey the substance of their work to others skilled in the art. A software implemented method or process is here, and generally, conceived to be a self-consistent sequence of steps leading to a desired result. These steps require physical manipulations of physical quantities. Often, but not necessarily, these quantities take the form of electrical or magnetic signals or values capable of being stored, transferred, combined, compared, and otherwise manipulated. It will be further appreciated that the line between hardware and software is not always sharp, it being understood by those skilled in the art that the software implemented processes described herein may be embodied in hardware, firmware, software, or any combination thereof. Such processes may be controlled by coded instructions such as microcode and/or by stored programming instructions in one or more non-transient media readable by a computer or processor. The code modules may alternately be stored in any computer storage system or device, such as hard disk drives, solid state memories, etc. The methods may alternatively be embodied partly or wholly in specialized computer hardware, such as ASIC or FPGA circuitry.

It will be clear to one having skill in the art that variations to the specific details disclosed herein can be made, resulting in other embodiments that are within the scope of the invention disclosed. Steps in the flowcharts may be performed in a different order, other steps may be added, or one or more may be removed without altering the main function of the system. Flowcharts from different figures may be combined in different ways. Screen shots may show more or less than the examples given herein. All parameters, dimensions and configurations described herein are examples only and actual values of such depend on the specific embodiment. Accordingly, the scope of the invention is to be construed in accordance with the substance defined by the following claims.

1. A system for obtaining consent to deliver refill prescription drugs comprising:
a client configured to:
receive an identification of a patient;
receive identifications of one or more prescription drugs that have been prescribed to the patient;
define a job that relates the patient to said drugs;
receive a command to print a label for a package in which said drugs are to be delivered to the patient, said label encoded with an identification of the job; and
transmit details of the job via a network;
a server connected via the network to the client, the server configured to receive details of the job transmitted from the client; and
an electronic signature pad connected via the network to the server, the pad configured to:
receive identification of the job;
receive identification of the patient;
retrieve the identifications of said drugs from the server;
display identification of the patient;
display identification of the job;
display a consent statement for future delivery of one or more of said drugs comprising:
an identification of each of said drugs; and
an individual selector for each of said drugs;
receive a selection from the patient of one or more of said drugs;
receive a signature from the patient for the consent statement, the signature also acknowledging receipt by the patient of the package; and
transmit the selection of one or more of said drugs and the signature to the server.

2. The system of claim 1, wherein the consent statement and signature are transmitted to the server.

3. The system of claim 2, wherein the server is configured to store the signature as:
confirmation that the package has been received by the patient; and
consent for future delivery to the patient of said selected drugs.

4. The system of claim 3, wherein the client is configured to retrieve the consent statement and signature from the server.

5. The system of claim 4, wherein the client is configured to display a copy of the signature to indicate that the package has been received by the patient.

6. The system of claim 4, wherein the client is configured to display an identification of each of said selected drugs and a copy of the signature alongside each of these identifications.

7. The system of claim 3, wherein the client is configured to create a document comprising the consent statement and the signature.

8. The system of claim 7, wherein the document comprises:
a name of the patient;
an address of the patient;
an identification of each of said selected drugs and a copy of the signature alongside each of these identifications; and
a date that the signature was received by the electronic signature pad.

9. The system of claim 1, wherein the client receives identifications of said drugs from a code scanning device connected to the client.

10. The system of claim 1, wherein the electronic signature pad receives the identification of the job from a code scanning device that scans the label.

11. The system of claim 10, wherein the electronic signature pad:
sends the identification of the job to the server; and, in response, receives the identification of the patient from the server.

12. The system of claim 10, wherein the code scanning device is physically connected to or integral to the electronic signature pad.

13. The system of claim 3, wherein:
the server is further configured to identify packages of different prescription drugs that have been delivered to the patient within a selected period of time; and
the client is further configured to display a representation of said identified packages.

14. A method for obtaining consent to deliver refill prescription drugs comprising:
receiving, by a client, an identification of a patient;
receiving, by the client, identifications of one or more prescription drugs that have been prescribed to the patient;
defining, by the client, a job that relates the patient to said drugs;
receiving, by the client, a command to print a label for a package in which said drugs are to be delivered to the patient, said label encoded with an identification of the job; and
transmitting, by the client, details of the job to a server;
receiving the identification of the job by an electronic signature pad connected via a network to the server;
receiving, by the pad, identification of the patient;
retrieving, by the pad, the identifications of said drugs from the server;
displaying, by the pad, identification of the patient;
displaying, by the pad, identification of the job;
displaying, by the pad, a consent statement for future delivery of one or more of said drugs comprising:
an identification of each of said drugs; and
an individual selector for each of said drugs;
receiving, by the pad, a selection from the patient of one or more of said drugs;
receiving, by the pad, a signature from the patient for the consent statement, the signature also acknowledging receipt by the patient of the package; and
transmitting the selection of one or more of said drugs and the signature from the pad to the server.

15. The method of claim 14, further comprising:
transmitting the consent statement and signature from the pad to the server; and
storing the signature in the server as:
confirmation that the package has been received by the patient; and
consent for future delivery to the patient of said selected drugs.

16. The method of claim 15, further comprising the client:
retrieving the consent statement and signature from the server;
displaying a copy of the signature to indicate that the package has been received by the patient; and
displaying an identification of each of said selected drugs and a copy of the signature alongside each of these identifications.

17. The method of claim 15, further comprising the client:
retrieving the consent statement and signature from the server; and
creating a document comprising:
a name of the patient;
an address of the patient;
an identification of each of said selected drugs and a copy of the signature alongside each of these identifications; and
a date that the signature was received by the electronic signature pad.

18. The method of claim 14, wherein the client receives identifications of said drugs from a code scanning device connected to the client.

19. The method of claim 14, wherein the electronic signature pad receives the identification of the job from a code scanning device that scans the label.

20. The method of claim 19, further comprising the electronic signature pad sending the identification of the job to the server, in response to which the pad receives the identification of the patient from the server.

21. Computer readable media comprising computer readable instructions that, when executed by one or more processors, cause:
a client to:
receive an identification of a patient;
receive identifications of one or more prescription drugs that have been prescribed to the patient;
define a job that relates the patient to said drugs;
receive a command to print a label for a package in which said drugs are to be delivered to the patient, said label encoded with an identification of the job; and
transmit details of the job via a network;
a server, connected via the network to the client, to receive details of the job transmitted from the client; and
an electronic signature pad, connected via the network to the server, to:
receive identification of the job;
receive identification of the patient;
retrieve the identifications of said drugs from the server;
display identification of the patient;
display identification of the job;
display a consent statement for future delivery of one or more of said drugs comprising:
an identification of each of said drugs; and
an individual selector for each of said drugs;
receive a selection from the patient of one or more of said drugs;
receive a signature from the patient for the consent statement, the signature also acknowledging receipt by the patient of the package; and
transmit the selection of one or more of said drugs and the signature to the server.
